(19) United States
(12) Patent Application Publication
(10) Pub. No.: US 2006/0143653 A1
(43) Pub. Date: Jun. 29, 2006

(54) Broadcasting receiver with functions of recommending broadcasting program and reservation-recording recommended program on network, and method for performing the functions

(75) Inventor: Jong Yeul Suh, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/267,531

(22) Filed: Nov. 4, 2005

(30) Foreign Application Priority Data
Dec. 24, 2004 (KR) 2004-0111912

(51) Int. Cl. H04N 5/445; G06F 13/00; G06F 3/00; H04N 7/025; H04N 7/10

(52) U.S. Cl. 725/46; 725/45; 725/32

(57) ABSTRACT

A broadcasting receiver with functions of recommending a broadcasting program and reservation-recording a recommended broadcasting program over a network, and method for performing the functions is provided in order to give and receive a recommendation for a genre of program that users favor between broadcasting receivers, and also reservation-record the recommended program. According to the invention, the broadcasting receivers on the network share identification information of each user, information on user-favored program genres, and IP address of each broadcasting receiver and have been registered as friends so that those receivers can recommend a favored genre of program that the users mutually favor, receive a recommendation for their favored genre of program, and perform the reservation-recording in accordance with selection of the user. As a result, the broadcasting receivers connected to the network can more easily reservation-record by receiving the recommendation for the genre of program that users mutually favor.

Pursuant to 35 U.S.C. § 119(a), this application claims the benefit of earlier filing date and right of priority to Korean Patent Application No. 10-2004-0111912, filed on Dec. 24, 2004, the content of which is hereby incorporated by reference herein in its entirety.

### BACKGROUND OF THE INVENTION

1. Field of the Invention

The present invention is directed to a broadcasting receiver with functions of recommending a broadcasting program and reservation(advance)-recording a recommended broadcasting program over a network, and method for performing the functions so as to reciprocate a recommendation for a genre of program that users favor between broadcasting receivers, and also reservation-record the recommended program.

2. Description of Related Art

Currently, users of broadcasting receiver may acquire information on broadcasting programs with respect to each channel using an Electronic Program Guide (EPG) provided by a broadcasting station, select a broadcasting signal of a desired channel to receive and view it, and execute various functions, including reservation-recording.

Also, the broadcasting receiver incorporates therein a Personal Video Recorder (PVR) with hard disc as storage means, which stores a received image and voice stream and then outputs the same at a user's desired time for its viewing.

Further, with the rapid growth of technologies associated with PVR and the prompt increase of diverse supplementary services using it, an attempt has already commenced to integrate the broadcasting receiver having PVR with such Internet service as a home network system or LAN, and it is a tendency that various related services and business models have been proposed. In particular, due to the ambiguity of boundary between a broadcasting receiver with PVR and a personal computer (PC), it is configured for such a broadcasting receiver to conduct various network related services by applying many functions provided by PC thereto.

Consequently, there is a high possibility that broadcasting receivers connected to a network intercommunicate information and functions of recommending a program thereamong and reservation(advance)-recording the recommended program based on the given communication are to be spotlighted as the network related services by the receivers.

### SUMMARY OF THE INVENTION

Accordingly, it is an object of the present invention to provide a broadcasting receiver with a function of recommending a genre of program favored by users to broadcasting receivers connected to a network, and method for performing the function.

Another object of the present invention is to provide a broadcasting receiver with a function of reservation-recording a program recommended by other broadcasting receivers connected to a network and method for performing the function.

In accordance with the object of the present invention, there is provided a broadcasting receiver with functions of recommending a broadcasting program and reservation-recording a recommended program over a network, the broadcasting receiver comprising: a demultiplexer for demultiplexing a broadcasting signal received through a tuner to separate an image/voice stream and an Electronic Program Guide (EPG) from the broadcasting signal; an identifier generator for generating program identifier information for each program name within the EPG information separated from the demultiplexer and storing the EPG information and the program identifier information in a memory; a data interface unit for interfacing identifier information of a program to be recommended by each broadcasting receiver and a plurality of other broadcasting receivers registered as friends over a network; a controller for recommending a favored genre of program between the broadcasting receiver and the plurality of other broadcasting receivers registered as said friends each other, based on a communication of the program identifier information via the data interface unit, and reservation-recording a program recommended by the plurality of other receivers registered as said friends in response to selection of a user; a Personal Video Recorder (PVR) for storing an image/voice stream of the program to be reservation-recorded by the controller; and an image/voice processor for outputting the image/voice stream stored in the PVR in an image/voice signal.

The controller of the invention comprises: a recommendation program detector for detecting information on the program from the memory, based on the program identifier information of the program transferred via the data interface unit; a reservation-recording processor for reservation-recording the program that the user wants to reservation-record in the PVR; a friend information storage unit for storing information on network addresses of the plurality of other broadcasting receivers registered as said friends, identification information of each receiver user, and information on favored program genres; a recommendee searcher for searching identification information of friends favoring the same genre as that of the program the user wishes to recommend, using the information stored in the friend information storage unit; and a recommendation information transmitter for transmitting the program identifier information of the program to other broadcasting receivers that correspond to identification information of friends selected by the user, among the identification information of said friends searched in the recommendee searcher.

The controller further comprises a user information transmitter for transferring the user identification information, information on user-favored program genre, and network address of the user own broadcasting receiver to the plurality of other broadcasting receivers registered as said friends.

The controller further comprises a notice unit for notifying the user of information indicating a presence of the recommendation of the program, if the program identifier information of the program recommended from the other broadcasting receivers is received through the data interface unit.

The data interface unit is connected to the network and configured to provide and receive information to and from the plurality of other broadcasting receivers registered as said friends via a guidance server for guiding the transfer of the data.

In accordance with the object of the present invention, there is provided a program recommendation method for a broadcasting receiver, the method comprising the steps of: demultiplexing a broadcasting signal received through a tuner to separate an image/voice stream and EPG from the broadcasting signal, generating program identifier information for each program name within the EPG information separated from the demultiplexer, and storing the EPG information and the program identifier information in a memory; searching identification information of friends favoring the same genre as that of the selected program from friends' identification information and information on the friend-favored program genres stored in advance, and displaying the searched information on a screen if a program is selected through the EPG information and an instruction for recommended search with respect to the program is inputted by a user; and transmitting the program identifier information of the program to other broadcasting receivers that correspond to identification information of friends selected by the user among the displayed friends' identification information, to thereby recommend the program.

The program identifier information is created by combining a broadcasting channel, a broadcasting time and a program genre for each program provided in the EPG information.

The number of the other broadcasting receivers for receiving the program identifier information of the program recommended by the selection of the user is limited to below a predefined number.

According to the present invention, identification information and information on favored program genre of each friend, and broadcasting receivers network addresses of said friends are transmitted and stored from a plurality of other broadcasting receivers registered as friends, prior to performing the program recommendation; and the transmission of the identification information and the information on preferable program genre of each friend, and broadcasting receivers network addresses of said friends from the plurality of other broadcasting receivers registered as said friends is made through a guidance server connected to the network to guide the transmission of data.

In accordance with the object of the present invention, there is provided a program reservation-recording method for a broadcasting receiver, the method comprising the steps of: demultiplexing a broadcasting signal received through a tuner to separate an image/voice stream and EPG from the broadcasting signal, generating program identifier information for each program name in the EPG information separated from the demultiplexer, and storing the EPG information and the program identifier information in a memory; detecting program information corresponding to the received program identifier information from the EPG information stored in the memory and displaying the detected information on a screen if program identifier information of a program is received by a program recommendation from other broadcasting receivers that have been registered as friends; and setting a reservation-recording of the recommended program responsive to selection of a user and reservation-recording the program in a PVR.

The said program reservation-recording method further comprises the step of notifying the user that the program has been recommended when the program identifier information of the program is received by the program recommendation of the other broadcasting receivers registered as said friends.

The notifying step is a step of notifying the recommendation of the program by displaying a predetermined symbol on the screen, or notifying the program recommendation by displaying a message window, including the user identification information of the broadcasting receiver which has recommended the program and the recommended program name.

The other broadcasting receivers registered as said friends receive and store user identification information, information on user-favored program genre, and network address of the user own broadcasting receiver in advance, from the broadcasting receiver; and the user identification information, the information on user-favored program genre, and the network address of the broadcasting receiver are transmitted to the other broadcasting receivers registered as said friends via a guidance server connected to the network to guide the transmission of data.

The program identifier information is created by combining a broadcasting channel, a broadcasting time and a program genre for each program provided by the EPG information.

Preferably, in the reservation-recording according to the invention, if the received program identifier information of the program designates a program in which the reservation-recording has already been set, no further repeated reservation-recording for the related program is to be made.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a diagram illustrating an embodiment of a broadcasting system according to the present invention;

FIG. 2 is a block diagram of a broadcasting receiver according to the present invention;

FIG. 3 is a block diagram illustrating a detailed configuration of the controller shown in FIG. 2;

FIG. 4 is a flowchart illustrating a method of recommending a program according to a preferred embodiment of the present invention;

FIG. 5 is a flowchart illustrating a method of reservation-recording a program according to a preferred embodiment of the present invention;

FIGS. 6A and 6B are exemplary views illustrating embodiments notifying the presence of the program recommendation according to the present invention; and

FIG. 7 is an exemplary view illustrating an embodiment recommending a program according to the present invention.

### DETAILED DESCRIPTION OF THE INVENTION

Now, a preferred embodiment of the present invention will be set forth in detail with reference to the attached drawings.

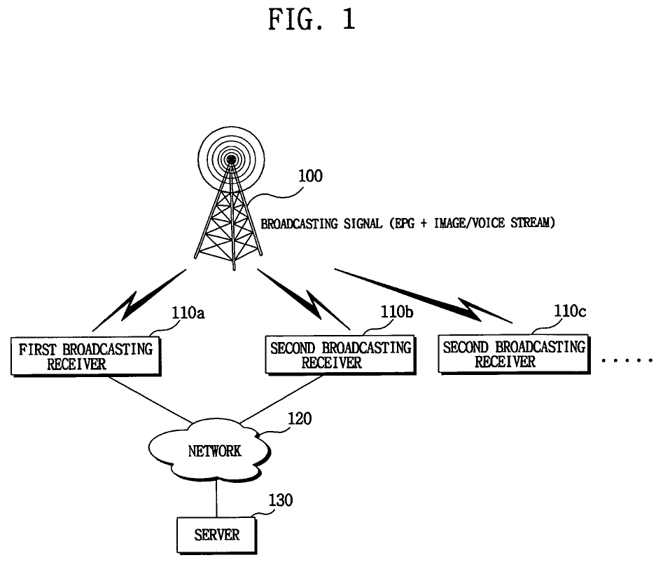

Referring to FIG. 1, there is shown an embodiment of a broadcasting system to which the present invention is applied. In the figure, it may be structured that a first broadcasting receiver 110a and a plurality of second broadcasting receivers 110b and 110c receive a broadcasting signal transmitted from a broadcasting station 100 and then enable a display of an image/voice signal and EPG information on a screen as well as an execution of various network related services through information exchange therebetween over a network 120, according to a user selection. Especially, the network 120 comprises a guidance server 130, which may be configured to help allow the first broadcasting receiver 110a and the plurality of second broadcasting receivers 110b and 110c to transmit certain data therebetween under the guidance of the server 130. The guidance server 130 used herein refers to such a server as an instant messenger server that enables the communication of information between terminal users through the use of an instant messenger.

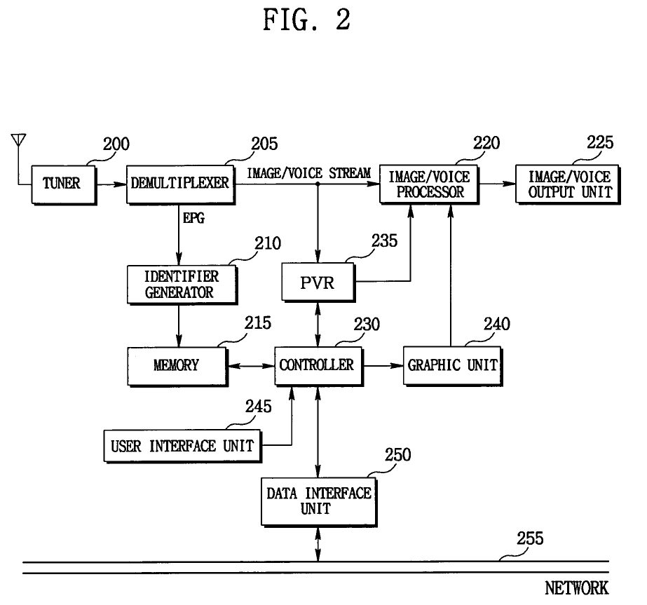

FIG. 2 illustrates a block diagram of a broadcasting receiver according to the present invention, in which the inventive broadcasting receiver motivates a tuner 200 to receive a broadcasting signal and then a demultiplexer 205 to separate an image/voice stream and EPG from the broadcasting signal. The separated image/voice stream is decoded and processed in an image/voice processor 220, and then delivered to an image/voice output unit 225 as an image/voice signal. Meanwhile, the separated EPG information is provided to an identifier generator 210 that serves to create program identifier information for each program name within the EPG information, and the EPG information and the program identifier information are then stored in a memory 215.

The term “program identifier information” implies information regarding a broadcasting channel and a broadcasting time of each program, and a genre of each program, wherein, for example, it may be created in a combined manner of “broadcasting channel+broadcasting time+genre code.” Of course, it should be apparent that the program identifier information may be produced in various fashions if each program can be identified.

Indicated by a reference numeral 230 is a controller that gives and receives program identifier information of a program that the broadcasting receiver and a plurality of other broadcasting receivers that have been registered as friends over a network want to recommend each other via a data interface unit 250, to thereby provide and get the program recommendation. For instance, if the controller 230 receives program identifier information of a program recommended by the plurality of other broadcasting receivers via the data interface unit 250, it detects program information corresponding to the received program identifier information from the EPG information stored in the memory 215 and then provides same to a graphic unit 240, thereby displaying the recommended program information on a screen. Meanwhile, upon receipt of a command for the reservation-recording of the recommended program via a user interface unit 245, the controller 230 prompts a PVR 235 to reservation-record said program by setting the reservation-recording thereof.

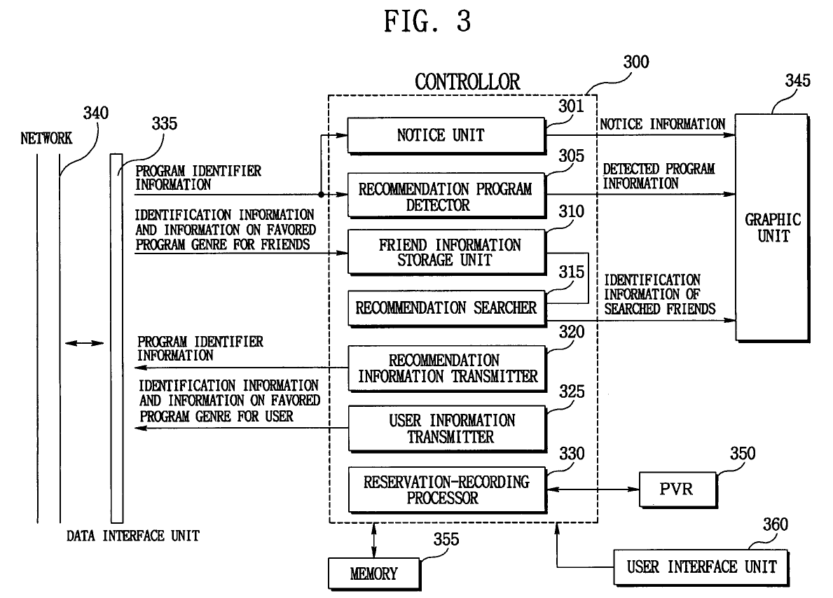

FIG. 3 is a block diagram illustrating a concrete configuration of the controller 300 shown in FIG. 2, wherein an operation of the controller 300 will be described in more detail.

The controller 300 comprises: a reservation-recording processor 330 for reservation-recording a program by selection of a user; a notice unit 301 for notifying a presence of a recommendation for a certain program from a plurality of other broadcasting receivers registered as friends; a recommendation program detector 305 for detecting information on the recommended program using program identifier information of said program; a friend information storage unit 310 for storing information on IP addresses of the plurality of other broadcasting receivers registered as said friends, identification information of each receiver user, i.e., said friends, and information on favored program genres; a recommendee searcher 315 for searching, through the information stored in said friend information storage unit 310, identification information of friends favoring the same genre as that of a program that the user wants to recommend; a recommendation information transmitter 320 for transmitting the program identifier information of the program to be recommended to other broadcasting receivers that corresponds to identification information selected by the user, among the identification information of said friends searched in the recommendee searcher 315; and a user information transmitter 325 for transferring identification information of the user, information on user-favored program genre, and IP address of the user own broadcasting receiver to the plurality of the other broadcasting receivers registered as said friends.

More specifically, the program recommendation according to the present invention is carried out by reciprocating program identifier information of a program that the broadcasting receivers registered as said friends on the network have recommended one another. For example, if program identifier information of a certain program is received via the data interface unit 335, the recommendation program detector 305 detects, from the memory 355, information on the program to which the received program identifier information designates, and then transmits the detected information to the graphic unit 345 to thereby display it on the screen. Hence, the user may confirm the detailed information on the recommended program and, if a user reservation-recording command for the recommended program is inputted through the user interface unit 360, the reservation-recording processor 330 sets the reservation-recording of the recommended program and then executes the reservation-recording in the PVR 350.

If the notice unit 301 receives the program identifier information of the program recommended by the other broadcasting receivers via the data interface unit 335, it displays a certain symbol indicating that the program has been recommended on the screen of the broadcasting receiver itself, or searches a name of the recommended program and identification information of a broadcasting receiver user who has recommended the program from the memory 355 and the friend information storage device 310 to display a message window including the searched information on the screen. In addition, the notice unit 301 may be configured to notify the user of the fact that the program has been recommended as a voice signal.

The recommendee searcher 315 searches identification information of friends favoring the same genre as that of the program to be recommended from the friend information storage unit 310 according to a user's recommendee search instruction, when the user wants to recommend a specific program to the plurality of other broadcasting receivers registered as said friends over the network, and then transmits the searched result to the graphic unit 345 to display it on the screen.

The recommendation information transmitter 320 serves to transmit program identifier information of the program recommended by the user to other broadcasting receivers corresponding to identification information selected by the user, out of the identification information of the friends searched through the recommendee searcher 315, thereby enabling the program recommendation.

The user information transmitter 325 functions to transmit the user own identification information, the information on favored program genre, and the IP address of the broadcasting receiver itself to the plurality of other broadcasting receivers registered as said friends over the network so that said receivers can recommend the user-favored genre of program to the user broadcasting receiver.

As mentioned above, the present invention is structured in such a manner that the users of the broadcasting receivers can receive a recommendation for a favored genre of program from the friends' broadcasting receivers, and conversely recommend the friends-favored genre of program, while sharing the identification information of each user, the information on preferable program genre, and the IP address of each broadcasting receiver between the broadcasting receivers registered as said friends.

In the meantime, the present invention may be configured to give and receive the identification information of each user, the information on favored program genre, and the IP addresses of the broadcasting receivers via the guidance server 130 between the broadcasting receivers registered as said friends on the network 120, 255, or 340, and also to participate in the transmission of the program identifier information of the certain program for the recommendation of the program between said broadcasting receivers.

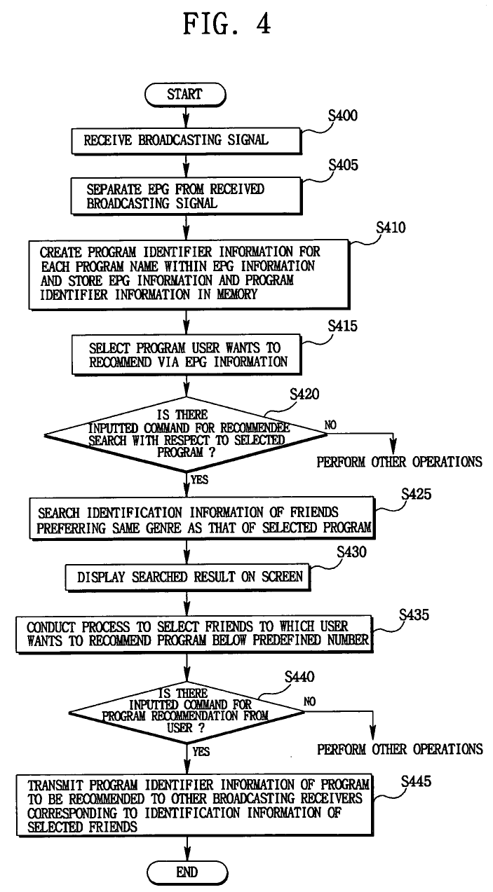

FIG. 4 is a flowchart illustrating a method of recommending a program according to a preferred embodiment of the present invention. In the figure, the program recommendation of the invention is conducted between broadcasting receivers registered as friends on a network. The present invention prompts those other broadcasting receivers to be registered as friends, prior to recommending a program to other broadcasting receivers connected to the network, in which IP addresses of the other broadcasting receivers, identification information of the receivers, and information on their favored program genre are stored in the friend information storage device 310.

In order to recommend a program, the broadcasting receiver separates EPG from a broadcasting signal received through the tuner 200 (S400 and S405), and then creates program identifier information for each program name in the separated EPG information, which in turn stores the EPG information and the program identifier information in the memory 215 or 355 (S410).

At step S415, if a program a user wishes to recommend is selected by the user through the EPG information, it is checked at step S420 whether a user's recommendee search command with respect to the selected program is inputted. If the user's recommendee search command is not inputted, the broadcasting receiver executes other operations in response to instruction of the user. However, if it is inputted, the receiver searches, at step S425, identification information of friends favoring the same genre as that of the program selected by the user from the friend information storage device 310. Successively, at step S430, the broadcasting receiver causes the searched friends identification information to be displayed on the screen so that the user can select identification information of friends to which he or she wants to recommend the program. In this embodiment, it is allowed at step S435 that the user may select only fewer friends than a predefined number, thereby preventing indiscreet program recommendation by the user.

After selecting the identification information of the friends to which the user wants to recommend the program as mentioned above, if the command for the recommendation is inputted at step S440, the broadcasting receiver allows the transmission of the program identifier information of the program recommended by the user to other broadcasting receivers corresponding to the identification information of the selected friends at step S445; but if the recommendation command is not inputted, other operations are carried out in response to instruction of the user.

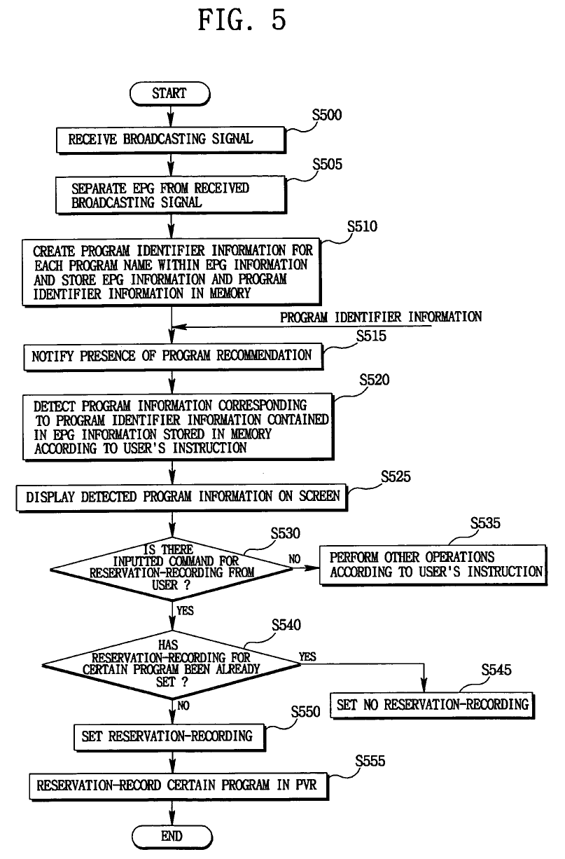

FIG. 5 is a flowchart showing a method of reservation-recording a program according to a preferred embodiment of the present invention. In the figure, the reservation-recording of the invention is performed by receiving a recommendation of a user-favored program from other broadcasting receivers registered as friends on a network, and then reservation-recording the recommended program. For this, when the user own broadcasting receiver registers the other broadcasting receivers as said friends over the network, the broadcasting receiver transmits the user's identification information, information on favored program genre, and the user IP address.

To reservation-record according to the invention, the broadcasting receiver receives, at step S500, a broadcasting signal via the tuner 200, and then separates, at step S505, EPG from the signal in the demultiplexer 205. And then, at step S510 the broadcasting receiver creates program identifier information for each program name in the EPG information and then stores the EPG information and the identifier information in the memory 215, or 355.

Meanwhile, when the program identifier information of the program recommended from the other broadcasting receivers registered as said friends is received via the network 120, 255, or 340, the broadcasting receiver of the invention notifies the fact that there exists the program recommendation (S515), detects program information corresponding to the received program identifier information from the EPG information stored in the memory 215, or 355 according to user instruction (S520), and displays the same on the screen (S525). Thereafter, the broadcasting receiver checks whether a user reservation-recording command for the program is inputted (S530), and, if not inputted, the broadcasting receiver performs other operations in response to instruction of the user (S535), and if inputted, it checks at step S540 whether the reservation-recording of the program has already been set. If the reservation-recording has already been set, no further reservation-recording is set (S545), otherwise, the reservation-recording is set (S550), and then the reservation-recording operation for the program is executed in the PVR 230, or 350 (S555). This can avoid an overlapped reservation-recording setting for the same program.

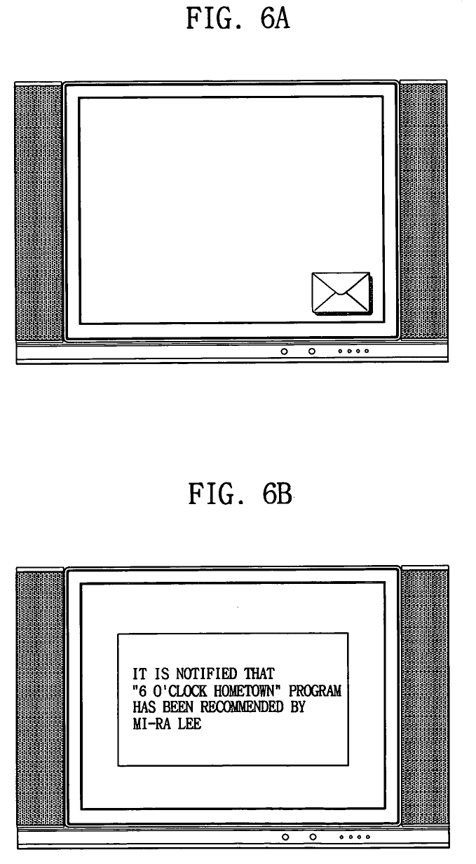

FIGS. 6A and 6B are exemplary views illustrating embodiments notifying the program recommendation according to the present invention, in which if there is a program recommendation from the other broadcasting receivers registered as said friends over the network, a certain symbol such as a letter envelop is displayed on the screen of the broadcasting receiver, as shown in FIG. 6A, thereby notifying that the program has been recommended.

Another example notifying the program recommendation is that a message window may be displayed with a name of recommended program and identification information of a broadcasting receiver's user who has recommended the program, as shown in FIG. 6B, which can notify the user of the same.

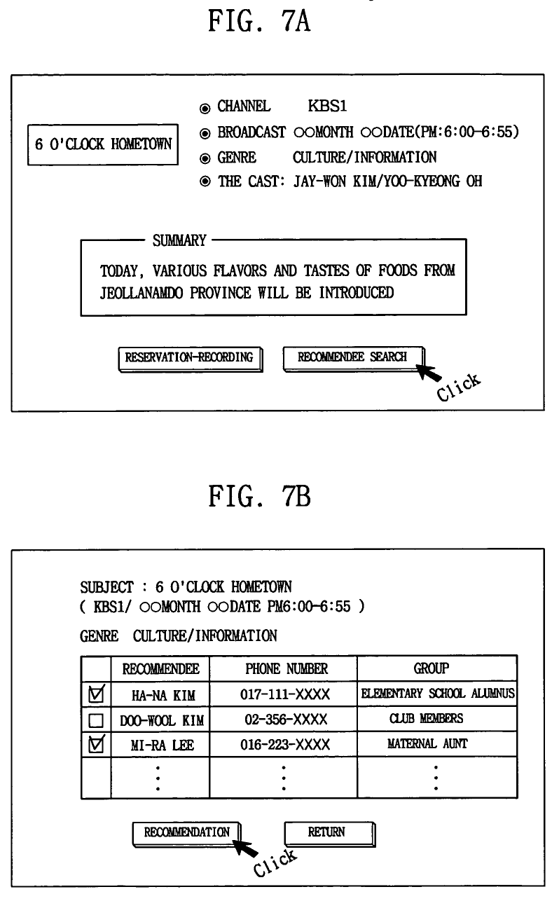

FIG. 7 illustrates an embodiment recommending a program according to the present invention. FIG. 7A shows an example of displaying information on a program selected by a user, or program recommended from other broadcasting receivers, and FIG. 7B shows a screen that may exhibit by clicking a recommendee search button in FIG. 7A.

Referring to FIG. 7A, there is shown a simple summary of broadcasting synopsis, along with channel information and broadcasting time of the program selected by the user, information on the program genre, and the player names. Based on the information, the user can set the reservation-recording by clicking a reservation-recording button, or search friends favoring the program genre by clicking the recommendee search button.

FIG. 7B shows a list made as a result of click of the recommendee search button in FIG. 7A, which contains names of searched recommendees, phone numbers, and identification information of each recommendee in a group to which the searched recommendees belong. And, the broadcasting receiver enables the user to select each recommendee to which the user wants to recommend the program via a check box for each recommendee. The number of recommendees who may be selected by the user via the check box is limited to below a predefined number. Further, upon click of a recommendation button, corresponding program identifier information is transmitted to other broadcasting receivers of recommendees selected by the user over the network. Meanwhile, if there exists no friend to be recommended among the searched recommendees, the user may again return to the screen shown in FIG. 7A via a return button.

It should be noted that the inventive methods set forth above may be implemented by software programs that are incorporated in any of the elements of the broadcasting receiver according to the invention, e.g., the controller.

According to the present invention, the broadcasting receivers connected to a network can more easily reservation-record by receiving a recommendation for a genre of program that users mutually favor.

Moreover, in case that the users wish to recommend a certain program, the present invention searches friends favoring the same genre as that of the program to be recommended and then recommends the program for other broadcasting receivers of the searched friends, thereby enabling the recommendation of the program more simply.

Although a preferred embodiment of the present invention has been shown and described in the foregoing, it will be apparent to those skilled in the art that various changes or modifications may be made thereto within the scope of the invention defined by the appended claims.

What is claimed is:

1. A broadcasting receiver with functions of recommending a broadcasting program and reservation-recording a recommended program over a network, the broadcasting receiver comprising:
a demultiplexer for demultiplexing a broadcasting signal received through a tuner to separate an image/voice stream and an Electronic Program Guide (EPG) from the broadcasting signal;
an identifier generator for generating program identifier information for each program name within the EPG information separated from the demultiplexer and storing the EPG information and the program identifier information in a memory;
a data interface unit for interfacing identifier information of a program to be recommended by each broadcasting receiver and a plurality of other broadcasting receivers registered as friends over a network;
a controller for recommending a favored genre of program that the broadcasting receiver and the plurality of other broadcasting receivers registered as said friends favor, based on a communication of the program identifier information via the data interface unit, and reservation-recording a program recommended by the plurality of other receivers registered as said friends in response to selection of a user;
a Personal Video Recorder (PVR) for storing an image/voice stream of the program to be reservation-recorded by the controller; and
an image/voice processor for outputting the image/voice stream stored in the PVR in an image/voice signal.

2. The broadcasting receiver as recited in claim 1, wherein the controller comprises:
a recommendation program detector for detecting information on the program from the memory, based on the program identifier information of the program transferred via the data interface unit;
a reservation-recording processor for reservation-recording the program that the user wants to reservation-record in the PVR;
a friend information storage unit for storing information on network addresses of the plurality of other broadcasting receivers registered as said friends, identification information of each receiver user, and information on favored program genres;
a recommendee searcher for searching identification information of friends favoring the same genre as that of the program that the user wishes to recommend, using the information stored in the friend information storage unit; and
a recommendation information transmitter for transmitting the program identifier information of the program to other broadcasting receivers that correspond to identification information of friends selected by the user, among the identification information of said friends searched in the recommendee searcher.

3. The broadcasting receiver as recited in claim 2, wherein the controller further comprises a user information transmitter for transferring the user identification information, information on user-favored program genre, and network address of the user own broadcasting receiver to the plurality of other broadcasting receivers registered as said friends.

4. The broadcasting receiver as recited in claim 2, wherein the controller further comprises a notice unit for notifying the user of information indicating a presence of the recommendation of the program, if the program identifier information of the program recommended from the other broadcasting receivers is received through the data interface unit.

5. The broadcasting receiver as recited in claim 1, wherein the data interface unit is connected to the network and configured to provide and receive information to and from the plurality of other broadcasting receivers registered as said friends via a guidance server for guiding the transfer of the data.

6. A program recommendation method for a broadcasting receiver, the method comprising the steps of:
demultiplexing a broadcasting signal received through a tuner to separate an image/voice stream and EPG from the broadcasting signal, generating program identifier information for each program name within the EPG information separated from the demultiplexer, and storing the EPG information and the program identifier information in a memory;
searching identification information of friends favoring the same genre as that of the selected program from friends identification information and information on the friends-favored program genres stored in advance, and displaying the searched information on a screen, if a program is selected through the EPG information and an instruction for recommendee search with respect to the program is inputted by a user; and
transmitting the program identifier information of the program to other broadcasting receivers corresponding to identification information of friends selected by the user among the displayed friends identification information, to thereby recommend the program.

7. The method as recited in claim 6, wherein the program identifier information is created by combining a broadcasting channel, a broadcasting time and a program genre for each program provided in the EPG information.

8. The method as recited in claim 6, wherein the number of the other broadcasting receivers for receiving the program identifier information of the program recommended by the selection of the user is limited to below a predefined number.

9. The method as recited in claim 6, wherein identification information and information on favored program genre of each friend, and broadcasting receivers network addresses of the friends are transmitted and stored from a plurality of other broadcasting receivers registered as friends, prior to performing the program recommendation.

10. The method as recited in claim 9, wherein the transmission of the identification information and the information on favored program genre for each friend, and broadcasting receivers network addresses of said friends from the plurality of other broadcasting receivers registered as said friends is made through a guidance server connected to the network to guide the transmission of data.

11. A program reservation-recording method for a broadcasting receiver, the method comprising the steps of:
demultiplexing a broadcasting signal received through a tuner to separate an image/voice stream and EPG from the broadcasting signal, generating program identifier information for each program name in the EPG information separated from the demultiplexer, and storing the EPG information and the program identifier information in a memory;
detecting program information corresponding to the received program identifier information from the EPG information stored in the memory and displaying the detected information on a screen, if program identifier information of a program is received by a program recommendation from other broadcasting receivers that have been registered as friends; and
setting a reservation-recording of the recommended program responsive to a selection of a user and reservation-recording the program in a PVR.

12. The method as recited in claim 11, further comprising the step of notifying the user that the program has been recommended when the program identifier information of the program is received by the program recommendation of the other broadcasting receivers registered as said friends.

13. The method as recited in claim 12, wherein the notifying step notifies the recommendation of the program by displaying a predetermined symbol on the screen.

14. The method as recited in claim 12, wherein the notifying step is a step of notifying the program recommendation by displaying a message window, including the user identification information of the broadcasting receiver which has recommended the program and the recommended program name.

15. The method as recited in claim 11, wherein the other broadcasting receivers registered as said friends receive and store user identification information, information on user-favored program genre, and network address of the user own broadcasting receiver in advance, from the broadcasting receiver.

16. The method as recited in claim 15, wherein the user identification information, the information on user-favored program genre, and the network address of the broadcasting receiver are transmitted to the other broadcasting receivers registered as said friends via a guidance server connected to the network to guide the transmission of data.

17. The method as recited in claim 11, wherein the program identifier information is created by combining a broadcasting channel, a broadcasting time and a program genre for each program provided by the EPG information.

18. The method as recited in claim 11, wherein if the received program identifier information of the program designates a program in which the reservation-recording has already been set, no further reservation-recording for the related program is to be made.
